(19) United States
(12) Patent Application Publication
(10) Pub. No.: US 2014/0334154 A1
(43) Pub. Date: Nov. 13, 2014

(54) DEVICE FOR LIGHTING A SUBJACENT AREA

(71) Applicant: LUCIBEL SA, Rueil Malmaison (FR)

(72) Inventor: Jean-Laurent Houot, Saint Clair de la Tour (FR)

(21) Appl. No.: 14/359,776

(22) PCT Filed: Nov. 19, 2012
(86) PCT No.: PCT/FR2012/052662

§ 371 Date: May 21, 2014

(30) Foreign Application Priority Data
Nov. 21, 2011 (FR) 11/60611

(51) Int. Cl. F21V 23/00; F21K 99/00

(52) U.S. Cl. CPC F21V 23/002; F21K 9/10
USPC 362/249.02

(57) ABSTRACT

This device (1) comprises:-means for attaching to and suspending from a support member,-a printed circuit (2) comprising (i) an upper face (13), tilted in the direction of the support, (ii) a lower face supporting and linking electronically amongst one another a plurality of electroluminescent diodes, (iii) a first end attached to a first end unit (4), and (iv) a second end attached to a second end unit (5), and-means for supporting and for free passage of at least one electric cord, connected to the first end unit (4) and to the second end unit (5) and intended for guiding each electric cable along the printed circuit (2) between the first end unit (4) and the second end unit (5), the means for supporting and for free passage of each electric cord extending along the printed circuit (2).

### TECHNICAL FIELD

The present invention relates to a lighting device, and more particularly a light-emitting diode lighting device, having a substantially longitudinal shape, of the type intended to be suspended from a support for lighting a subjacent area.

### BACKGROUND

It is known to use lighting devices having a substantially longitudinal shape, of the type intended to be suspended from a support for lighting a subjacent area, for example of the fluorescent tube type, suspended from a support, generally the ceiling of a room, in order to light a subjacent area.

However, these existing devices require a large and bulky wiring, particularly due to the length of the electric cables. Generally, they do not offer the possibility of an ordered arrangement of the electric cables. Thus, the electric cables are often disposed in bulk, which sometimes generates overall dimension and disturbance, for example for maintenance operations.

Moreover, taking into account the use to which are generally intended the fluorescent tubes, it is important that they have a long lifespan and lower power consumption.

### BRIEF SUMMARY

The invention aims to overcome all or part of these drawbacks by proposing a lighting device providing the possibility to orderly arrange the electric cable(s) and thus having a lesser overall dimension.

To this end, the invention provides a lighting device of a subjacent area, characterized in that it comprises:
means for attaching to and suspending from a support, in order to light a subjacent area,
a printed circuit comprising an upper face, intended to be oriented in the direction of the support, a lower face supporting and electrically connecting together a plurality of light-emitting diodes, a first end fastened to a first end housing intended to receive power supply means of the light-emitting diodes, and a second end fastened to a second end housing, and
means for supporting and passing at least one electric cable, fastened to the first end housing and to the second end housing and intended to guide each electric cable along the printed circuit between the first end housing and the second end housing, the means for supporting and passing each electric cable extending along the printed circuit.

Thus, the lighting device according to the invention provides a lesser overall dimension, thanks to the means for supporting and passing each electric cable which allow an ordered arrangement of each electric cable along the printed circuit. The light-emitting diodes ensure a long lifespan and a substantially reduced power consumption.

According to one feature of the lighting device according to the invention, the means for supporting and passing each electric cable comprise at least one profile, each profile comprising a first end connected to the first end housing, a second end connected to the second end housing, and a cavity opening at the first end and the second end and intended to receive each electric cable.

According to yet another feature of the lighting device according to the invention, the first end housing and the second end housing are shaped to receive respectively the first end and the second end of each profile, and the first end housing and the second end housing comprise at least one opening arranged facing the cavity of each profile.

Advantageously, the printed circuit comprises two side edges each extending from the first end to the second end of the printed circuit and each profile is shaped to fit the contour of one of the side edges.

Thus, each electric cable advantageously passes on either side of the printed circuit. This allows to avoid disposing it/them in bulk above the upper face. This results in a lesser overall dimension, and also in the absence of obstruction of the space located between the upper face and the support.

According to one feature of the lighting device according to the invention, each profile comprises two ribs delimiting therebetween a space intended to receive the side edge of the printed circuit.

Advantageously, each profile is made of metal, for example of aluminum.

This feature has the advantage to provide a good thermal conduction between the printed circuit and each profile. Each profile thus contributes to the dissipation of heat generated by the lighting device in operation.

According to one embodiment, the upper face of the printed circuit is in direct contact with the ambient air.

Thus, the thermal dissipation of heat generated by the lighting device in operation is directly ensured by the contact of the upper face of the printed circuit with the ambient air. This also allows to eliminate the need to use a heat sink connected to the upper face of the printed circuit, thus allows to limit overall dimension.

According to another feature of the lighting device according to the invention, the first end housing and the second end housing each comprise a protruding portion projecting beyond a plane comprising the upper face of the plate, each protruding portion being intended to be attached to the support via attaching and suspending means.

Thus, the upper face of the plate is disposed at a distance from the support when the device is attached to and suspended from the support. Maintaining a predetermined distance between the upper face of the printed circuit and the support allows to ensure the direct contact between the upper face and the ambient air. This allows to ensure the existence between the upper face and the support of an air volume suitable for efficient thermal dissipation. The more the space left between the upper face of the plate and the support is great, the more the amount of air likely to dissipate the heat generated by the lighting device in operation will be significant, and the more this air will be able to be renewed by convection.

Advantageously, the means for attaching to and suspending from a support comprise at least one attaching part substantially in an inverted U-shape, each attaching part comprising a base intended to be attached to the support by attaching means and two legs intended to be attached to the first end housing or to the second end housing, each leg comprising at least one flange shaped to be inserted in a space delimited by two notches arranged on the first end housing or the second end housing.

Thus, the lighting device according to the invention can be detached from the support by an operator in several phases. This proves to be particularly advantageous for lighting devices with significant dimensions (particularly with great length). Indeed, the operator can initially act on the means for attaching the legs to the first or second end housing. The first or second end housing (hence the lighting device) is then retained only by the cooperation of the flange and the notches, the flange being engaged in the space delimited by the notches. This gives the operator time to clear the other end housing in the same way. When the device is no longer retained by the engagement of the flanges of the legs between the notches of the end housings, the user only has to pull toward himself the lighting device so as to overcome the resistance due to the engagement of the flanges in the space delimited by the respective notches.

According to one feature of the lighting device according to the invention, the second end housing is intended to receive means for receiving a wireless signal and means for controlling the power supply means intended to control the switching on or off of the light-emitting diodes according to the information received by the means for receiving the wireless signal.

Thus, switching on and off the light-emitting diodes of the device according to the invention can be remotely controlled, for example by detecting the presence of a person entering or leaving the room in which is/are disposed the lighting device(s) according to the invention.

Advantageously, the second end housing comprises means for passing at least one electric cable for the connection to the first end housing of a distinct lighting device.

Thus, the lighting device according to the invention can be connected to another lighting device having the aforementioned features so as to form an assembly of lighting devices, according to the invention, intended to light together a room.

### BRIEF DESCRIPTION OF THE DRAWINGS

Other features and advantages of the present invention will become apparent from the description given below of an embodiment, given by way of non-limiting example, with reference to the accompanying drawings wherein:

FIG. 1 is a side view of a lighting device according to one embodiment of the invention,

FIG. 2 is a perspective top view of a lighting device according to one embodiment of the invention,

FIG. 3 is a perspective bottom view of a lighting device according to one embodiment of the invention,

FIG. 4 is a sectional view along the line I-I of FIG. 2,

FIG. 5 is a bottom perspective view of a lighting device according to one embodiment of the invention, of which optics and a portion of the first end housing have been removed,

FIG. 6 is a side view of a portion of the lighting device according to one embodiment of the invention,

FIG. 7 is a side view of a portion of a lighting device according to one embodiment of the invention, similar to FIG. 6, but of which attaching piece has been removed,

FIG. 8 is a perspective view of an attaching piece of a lighting device according to one embodiment of the invention,

FIG. 9 is a front view of an attaching piece of a lighting device according to one embodiment of the invention,

FIG. 10 is a perspective view of an end of the lighting device according to one embodiment of the invention, wherein some components have been hidden for better visibility.

### DETAILED DESCRIPTION

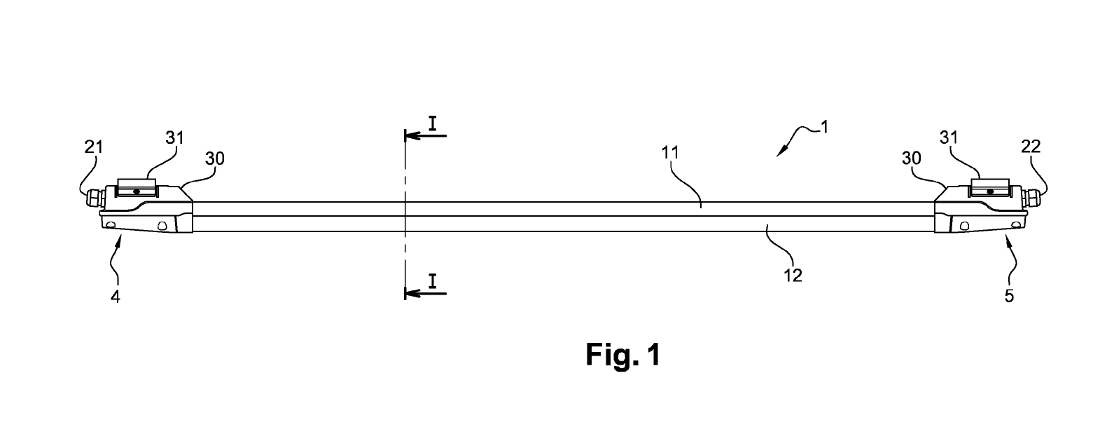

FIG. 1 shows a lighting device 1 for a subjacent area, i.e. an area located below the lighting device 1.

The light-emitting diode lighting device 1 comprises a printed circuit 2, a plurality of light-emitting diodes 3, a first end housing 4, a second end housing 5, means for supporting and passing at least one electric cable 10, here two profiles 11, and means for attaching to and suspending from a support (for example the ceiling of a room). The means for attaching to and suspending from the support will be described hereinafter in more detail.

As can be seen in FIG. 1, the lighting device 1 also comprises an optics 12 connected to the first end housing 4, to the second end housing 5, and allowing diffusion of the light emitted by the light-emitting diodes 3 according to a predetermined angle range. This contributes to a better distribution of light and prevents the risk of glare when a person located in the room looks directly at the lighting device 1. Particularly, the optics 12 may have a substantially semi-cylindrical shape.

The printed circuit 2 comprises an upper face 13 intended to be oriented in the direction of the support, and a lower face 14 supporting and electrically connecting together the light-emitting diodes 3. For example, the light-emitting diodes 3 are welded on the lower face 14 of the printed circuit 2.

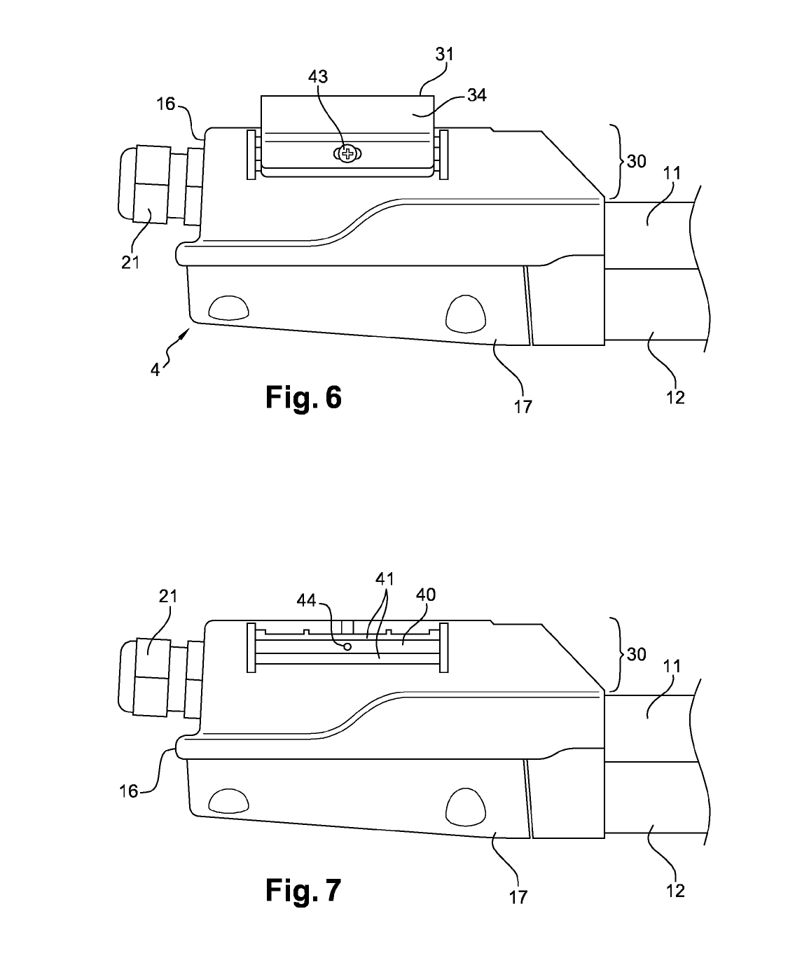

In the example of FIGS. 1 to 7, the printed circuit 2 is in the form of a rectangular plate. By plate is meant any element of which one dimension (thickness) is negligible compared to the other two dimensions.

Light-emitting diodes 3, shown schematically in FIG. 5 (the optics 12 having been removed) may be advantageously light-emitting diodes 3 of high power, i.e. of a power equal to or greater than one watt.

The printed circuit 2 has a first end 2a fastened to the first end housing 4 and a second end fastened to the second end housing 5. It also comprises two side edges 15, each joining its first end 2a and its second end.

The first end housing 4 may be formed in particular with two distinct portions 16, 17 (for example two plastic injection pieces), delimiting, once assembled, a volume intended to receive the power supply means, and an electrical connector 20, visible in FIG. 5.

The power supply means, known to those skilled in the art, are adapted to power light-emitting diodes 3. Particularly, they can allow to adapt the current and/or the supply voltage of the light emitting diodes 3. They may include a direct current source. They may include a transformer.

The first end housing 4 is intended to be connected to a local power grid.

It may comprise, as can be seen in FIG. 5, means for passing electric cables, for example a cable gland 21.

The second end housing 5 may be similar to the first end housing 4, i.e. formed by assembling two distinct parts delimiting an internal volume. This volume is intended to receive means for receiving a wireless signal and means for controlling the power supply means intended to control the switching on or off of the light-emitting diodes 3 according to the information received by the means for receiving the wireless signal. These means for controlling and these means for receiving the wireless signal are made in a manner known by those skilled in the art.

The second end housing 5 may also comprise means for passing, for example a cable gland 22, each electric cable 10 out of the volume delimited by each of its parts.

Thus, it is possible to electrically connect one after another several lighting devices 1 according to the invention, in parallel or in series.

Each profile 11 comprises two ends, a first end fastened to the first end housing 4, a second end fastened to the second end housing 5, and a cavity 23 opening at the first end and the second end. The cavity 23 is intended to receive each electric cable 10.

An electrically insulating sheath may be placed in the cavity 23 and contain the electric cable(s) 10.

The first end housing 4 and the second end housing 5 have openings 24 arranged facing the ends of each profile 11 for the inlet and the outlet of each electric cable 10 of one of the end housings 4, 5 in each profile 11 and vice versa.

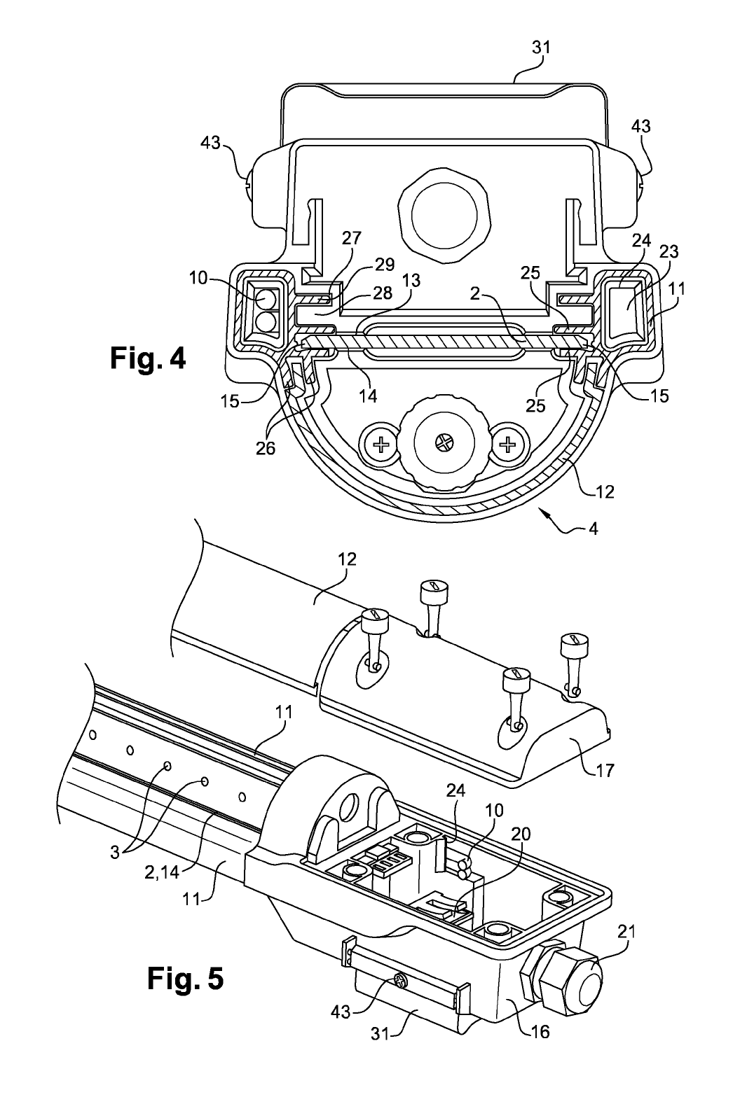

As can be seen in FIG. 4, each profile 11 is shaped to be connected to a side edge 15 of the printed circuit 2. Indeed, each profile 11 comprises two ribs 25 delimiting therebetween a groove or a space intended to receive the side edge 15 of the printed circuit 2.

The profiles 11 are advantageously shaped to fit the shape of the printed circuit 2, particularly its side edges 15. Here, the profiles 11 extend longitudinally in a straight line, each side edge 15 having a rectilinear contour.

The profiles 11 are intended to run along the side edges 15, so as to pass each electric cable 10 on either side of the printed circuit. The profiles 11 are in direct contact with the side edges 15 of the printed circuit 2. As can be seen in the different figures, they run along the side edges 15 along the entire length of the side edges 15 separating the first end housing 4 and the second end housing 5.

The profiles 11 are also shaped to similarly receive the optics 12, as can be seen in FIG. 4. Thus, the profiles 11 may comprise two ribs 26 delimiting therebetween a groove intended to receive an edge of the optics 12.

The first end and the second end of each profile 11 are adapted to be respectively inserted into the first end housing 4 and into the second end housing 5. The first end housing 4 and the second end housing 5 are thus shaped to receive each of the ends of the profiles 11.

Particularly, the first end housing 4 and the second end housing 5 comprise adjacent groove 27 and rib 28 intended to cooperate with the rib 29 arranged on each profile 11. This rib 29 delimits, with one of the ribs 25, a groove or a space which is able to receive the rib 28 of the first or the second end housing 4, 5. One of the ribs 29 of each profile 11 is in turn intended to be inserted into the groove 27 of the first or the second end housing 4, 5.

Each profile 11 is thus assembled to the first and the second end housings 4, 5 by relative translation.

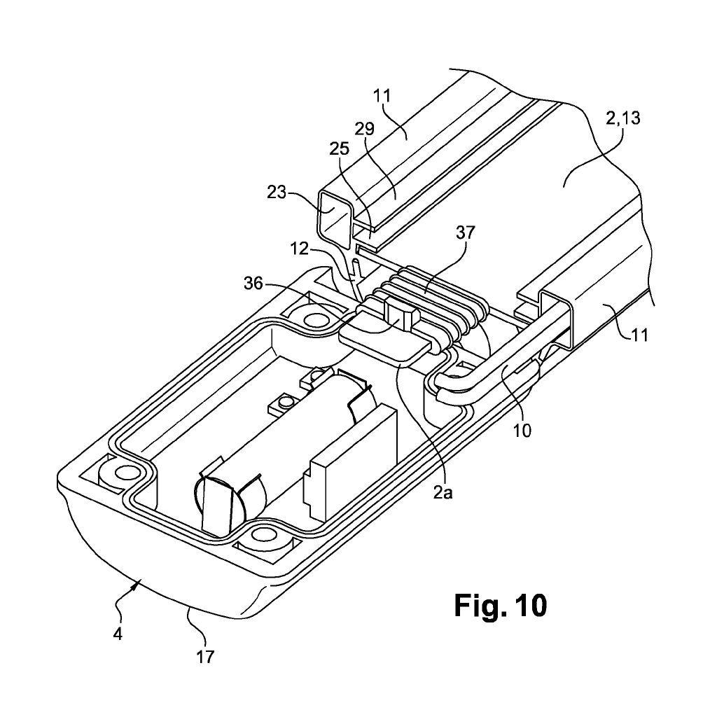

As can be seen in FIG. 10, which shows the inside of the first end housing 4 comprising the power supply means of the light-emitting diodes 3, an attaching member, for example a pin 36 is inserted into a hole arranged on the first end 2a of the printed circuit 2. The pin 36 prevents withdrawal of the first end 2a of the printed circuit 2 out of the first end housing 4. A sealing member 37, within which is inserted the first end 2a of the printed circuit 2, seals the interior of the first end housing 4. The second end of the printed circuit 2 is similarly attached to the second end housing 5.

Thus, the printed circuit 2, the first end housing 4, the second end housing 5 and the profiles 11 are assembled and held in position relative to each other.

In the embodiment of the lighting device 1 described herein, the profiles 11 are made of aluminum. This contributes to the thermal dissipation of heat generated by the lighting device 1 in operation.

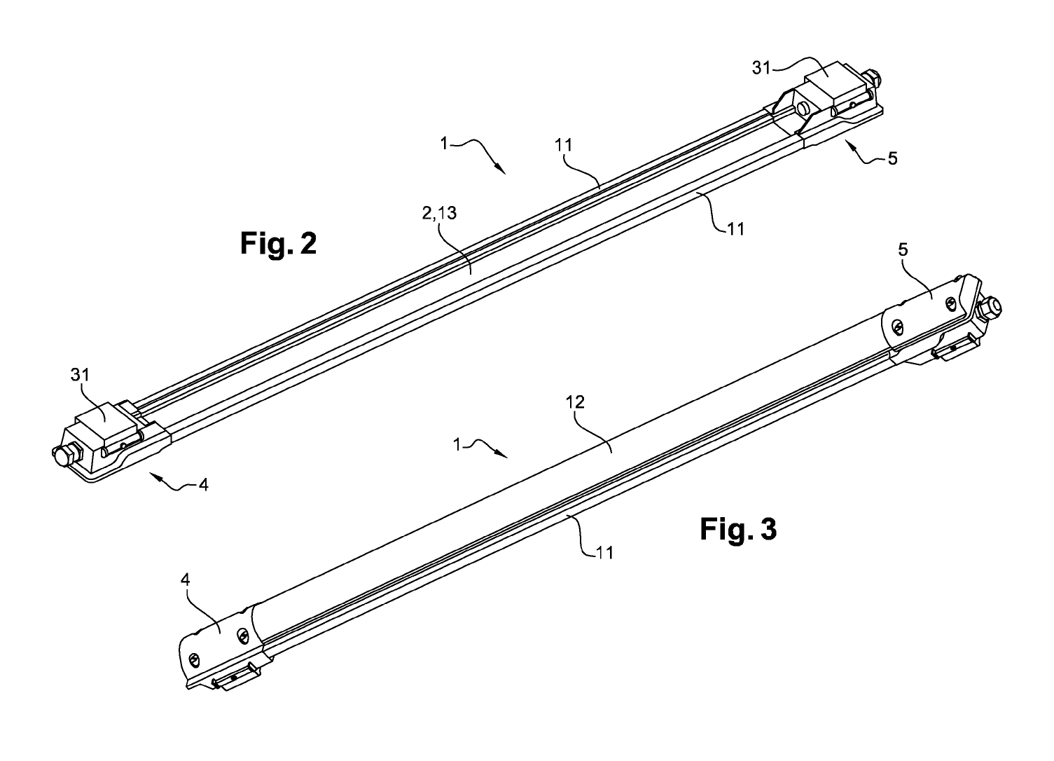

The upper face 13 of the printed circuit 2 may be in direct contact with the ambient air, as can be seen in FIG. 2.

To ensure that direct contact between the upper face 13 and the ambient air, the first end housing 4 and the second end housing 5 comprise here a protruding portion 30. This protruding portion 30 extends beyond a plane comprising the upper face 13. This protruding portion 30 guarantees holding a predetermined distance between the upper face 13 and the support when the lighting device 1 is attached to the support.

Each protruding portion 30 is intended to be attached to the support via attaching and suspending means.

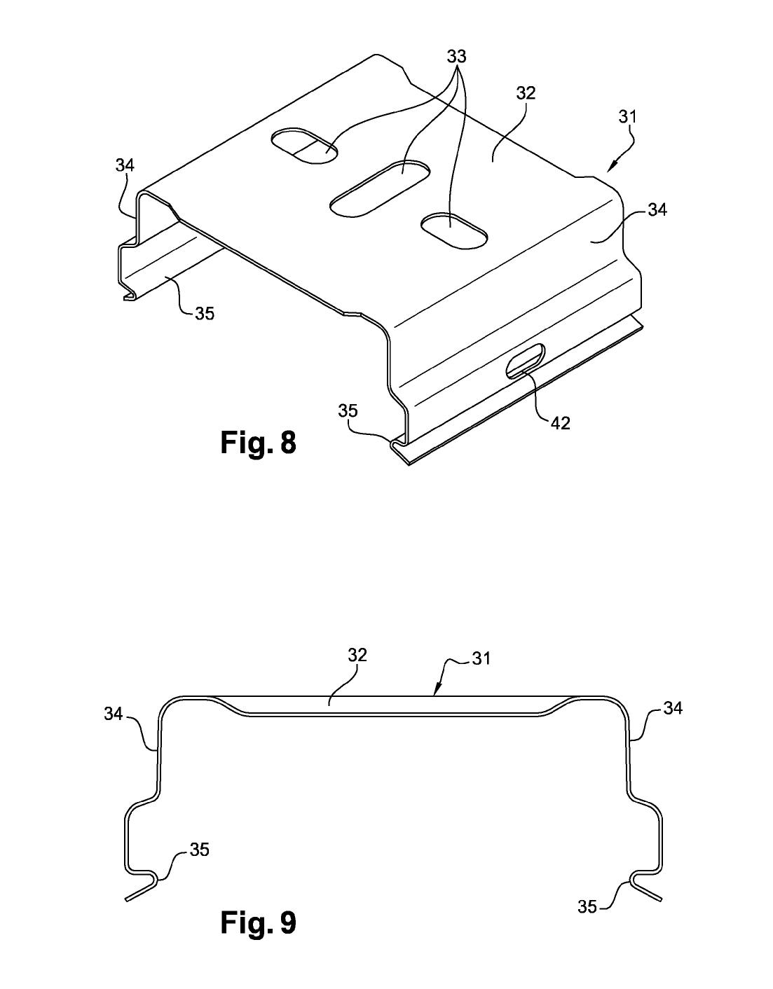

According to the embodiment shown in FIGS. 1 to 9, the means for attaching to and suspending from a support are intended to ensure attaching removably or permanently the device 1 to the support. They comprise two attaching parts 31.

As illustrated in FIG. 9, the attaching parts 31 may have substantially an inverted U-shape. They comprise a base 32 intended to be attached to the support by attaching means, for example one or more screw(s) engaging in holes 33 arranged in the base 32. Thus, the attaching parts 31 are intended to be permanently fastened to the support.

The attaching parts 31 also comprise two legs 34 intended to be attached to the first end housing 4 or to the second end housing 5. Each leg 34 comprises a flange 35. The flange 35 is shaped to cooperate in a space 40. The space 40 is delimited by two notches 41 arranged on the first or the second end housing 4, 5. Particularly, it is possible to provide a flange 35 and notches 41 of complementary shape.

To allow the insertion of the flange 35 into the space 40, the legs 34 are capable of bending, particularly when the flange 35 comes against one of the notches 41. The cooperation of the legs 34 (with their flanges 35) and the notches 41 of the first and second end housings 4, 5 allows to removably attach the lighting device 1 to the support in the extent that a user may remove or set up the lighting device 1 manually without using a tool, for example a wrench or a screwdriver.

To attach permanently the lighting device 1 to attaching pieces 31 and hence to the support, it is possible to provide apertures 42 on the legs 34 of the attaching pieces. These apertures 42 are intended to receive an attaching member 43, for example a screw, one end of which is intended to be inserted into a hole 44 arranged on the first end housing 4 and the second end housing 5.

Advantageously, this hole 44 is located between two successive notches 41, in the space 40, as can be seen in FIG. 7.

Of course, the invention is not limited to the embodiment described above, this embodiment having only been given as an example. Modifications remain possible, particularly from the point of view of the constitution of the various elements or by substitution of technical equivalents, without necessarily departing from the scope of protection of the invention.

1. A lighting device for a subjacent area, comprising:
means for attaching to and suspending from a support, in order to light a subjacent area,
a printed circuit comprising an upper face, intended to be oriented in the direction of the support, a lower face supporting and electrically connecting together a plurality of light-emitting diodes, (iii) a first end fastened to a first end housing intended to receive power supply means of the light-emitting diodes, and a second end fastened to a second end housing, and
means for supporting and passing at least one electric cable, fastened to the first end housing and to the second end housing and intended to guide said at least one electric cable along the printed circuit between the first end housing and the second end housing, the means for supporting and passing said at least one electric cable extending along the printed circuit.

2. The lighting device according to claim 1, wherein the means for supporting and passing said at least one electric cable comprise at least one profile, said at least one profile comprising a first end connected to the first end housing, a second end connected to the second end housing, and a cavity opening at the first end and at the second end and intended to receive said at least one electric cable.

3. The lighting device according to claim 2, wherein the first end housing and the second end housing are shaped to respectively receive the first end and the second end of said at least one profile, and wherein the first end housing and the second end housing comprise at least one opening arranged facing the cavity of said at least one profile.

4. The lighting device according to claim 2, wherein the printed circuit comprises two side edges each extending from the first end to the second end of the printed circuit and wherein said at least one profile is shaped to fit the contour of one of the side edges.

5. The lighting device according to claim 4, wherein said at least one profile comprises two ribs delimiting therebetween a space intended to receive the side edge of the printed circuit.

6. The lighting device according to claim 1, wherein the upper face of the printed circuit is in direct contact with the ambient air.

7. The lighting device according to claim 6, wherein the first end housing and the second end housing each comprise a protruding portion projecting beyond a plane comprising the upper face of the printed circuit, each protruding portion being intended to be attached to the support via attaching and suspending means.

8. The lighting device according to claim 1, wherein the means for attaching from and suspending to a support comprise at least one attaching piece substantially in an inverted U-shape, each attaching piece comprising a base intended to be attached to the support by attaching means and two legs intended to be attached to the first end housing or to the second end housing, each leg comprising at least one flange shaped to be inserted into a space delimited by two notches arranged on the first end housing or the second end housing.

9. The lighting device according to claim 1, wherein the second end housing comprises means for passing at least one electric cable for connection to the first end housing of a distinct lighting device.
